(19) United States
(12) Patent Application Publication
(10) Pub. No.: US 2013/0076670 A1
(43) Pub. Date: Mar. 28, 2013

(54) DUAL-MODE TABLET AND DETECTING AND SWITCHING METHOD FOR INPUT SIGNALS THEREOF

(71) Applicants: Wen-Tai WU, New Taipei (TW); Yu-Chi WANG, New Taipei (TW)

(72) Inventors: Wen-Tai WU, New Taipei (TW); Yu-Chi WANG, New Taipei (TW)

(73) Assignee: KYE SYSTEMS CORP., New Taipei (TW)

(21) Appl. No.: 13/613,036

(22) Filed: Sep. 13, 2012

(30) Foreign Application Priority Data
Sep. 23, 2011 (TW) 100134467

(51) Int. Cl. G06F 3/041

(52) U.S. Cl. 345/173

(57) ABSTRACT

A dual-mode tablet and a detecting and switching method for input signals thereof are provided. The dual-mode tablet includes an electromagnetic induction module and a touch input module. The microprocessor controls the electromagnetic induction module to electronically connect to an induction coil group and detects whether any electromagnetic signal is received. After the electromagnetic induction module receives one electromagnetic signal completely, the microprocessor controls the touch input module to electronically connect to the induction coil group. When the microprocessor receives a touch input signal, the microprocessor alternately controls one of the electromagnetic induction module and the touch input module to electronically connect to the induction coil group. When the microprocessor detects one electromagnetic signal is received, the electromagnetic induction module electronically connects to the induction coil group continuously until the electromagnetic signal is received completely.

### CROSS-REFERENCE TO RELATED APPLICATIONS

This non-provisional application claims priority under 35 U.S.C. §119(a) on Patent Application No(s). 100134467 filed in Taiwan, R.O.C. on Sep. 23, 2011, the entire contents of which are hereby incorporated by reference.

### BACKGROUND

1. Technical Field

The disclosure relates to a tablet and a detecting and switching method for input signals thereof, and more particularly to a dual-mode tablet and a detecting and switching method for input signals thereof.

2. Related Art

With the development of technology, many human interfaces having touch function are developed. Such human interfaces may be implemented in not only an individual tablet but also a display device. Generally, touch pens and fingers are two main types for the touch function. For the pen touch function, the position where the electromagnetic variation is caused is determined by way of detecting electromagnetic variation between the tablet and the induction pen. For the finger touch function, the position where finger presses is determined by way of detecting capacitance variation caused by pressing a tablet.

Based on the benefit of the above touch function, the touch function is implemented in display device. Such a display device having the touch function is called “touch display device.” FIG. 1 illustrates a schematic diagram of the dual-mode tablet technology of the prior art. The touch display device 100 includes multiple antennas 112, an electromagnetic signal receiving module 110, a touch sensing module 121, a processing unit 131, a display unit 141 and a display driver 151. The processing unit 131 selectively controls the electromagnetic signal receiving module 110 and the touch sensing module 121 to receive electromagnetic signals or touch signals. Both of the electromagnetic signal receiving module 110 and the touch sensing module 121 are disposed in the touch display device 100, so user can operate the touch display device 100 more intuitively by pen writing or finger writing.

However, it is difficult for a manufacturer to manufacture and repair such a touch display device 100. When one element of the touch display device 100 is broken, the complete touch display device 100 has to be sent for repair. This causes high manufacture cost and high repair cost.

### SUMMARY

The disclosure is a dual-mode tablet, which includes an induction coil group, an electromagnetic induction module, a touch input module and a microprocessor. The electromagnetic induction module electronically connects to the induction coil group selectively and is configured to receive electromagnetic signals. The touch input module electronically connects to the induction coil group selectively and is configured to receive touch input signals. The microprocessor electronically connects to the electromagnetic induction module and the touch input module and is configured to control one of the electromagnetic induction module and the touch input module to electronically connect to the induction coil group.

The electromagnetic induction module electronically connects to the induction coil group when the microprocessor operates under an electromagnetic induction mode. The microprocessor continuously operates under the electromagnetic induction mode and determines whether next electromagnetic signal exists, when receiving one electromagnetic signal under the electromagnetic induction mode. The microprocessor operates under a touch input mode instead of the electromagnetic induction mode when no electromagnetic signal exists.

The touch input module and the electromagnetic induction module electronically connect to the induction coil group alternately to receive one touch input signal or one electromagnetic signal when the microprocessor operates under the touch input mode. When the microprocessor detects the next electromagnetic signal exists in a second loop, the microprocessor operates under the touch input mode instead of the electromagnetic induction mode and receives the next electromagnetic signal until the next electromagnetic signal is received completely.

Moreover, the disclosure provides a detecting and switching method for input signals, which is adapted to a dual-mode tablet including an electromagnetic induction module and a touch input module. The electromagnetic induction module is controlled by a microprocessor operating under an electromagnetic induction mode, to electronically connect to an induction coil group to receive an electromagnetic signal. After the electromagnetic signal is received completely, the microprocessor operates under a touch input mode.

Under the touch input mode, the electromagnetic induction module and the touch input module electronically connects to the induction coil group alternately to receive a touch input signal or a next electromagnetic signal. When the microprocessor detects that the next electromagnetic signal exists under the touch input mode, the dual-mode tablet operates under the electromagnetic induction mode. When the microprocessor receives the next electromagnetic signal completely, the dual-mode tablet returns to operate under the touch input mode. After the microprocessor receives the touch input signal completely under the touch input mode, the dual-mode tablet operates under the electromagnetic induction mode.

For purposes of summarizing, some aspects, advantages and features of some embodiments of the disclosure have been described in this summary. Not necessarily all of (or any of) these summarized aspects, advantages or features will be embodied in any particular embodiment of the disclosure. Some of these summarized aspects, advantages and features and other aspects, advantages and features may become more fully apparent from the following detailed description and the appended claims.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic diagram of the dual-mode tablet technology of the prior art;

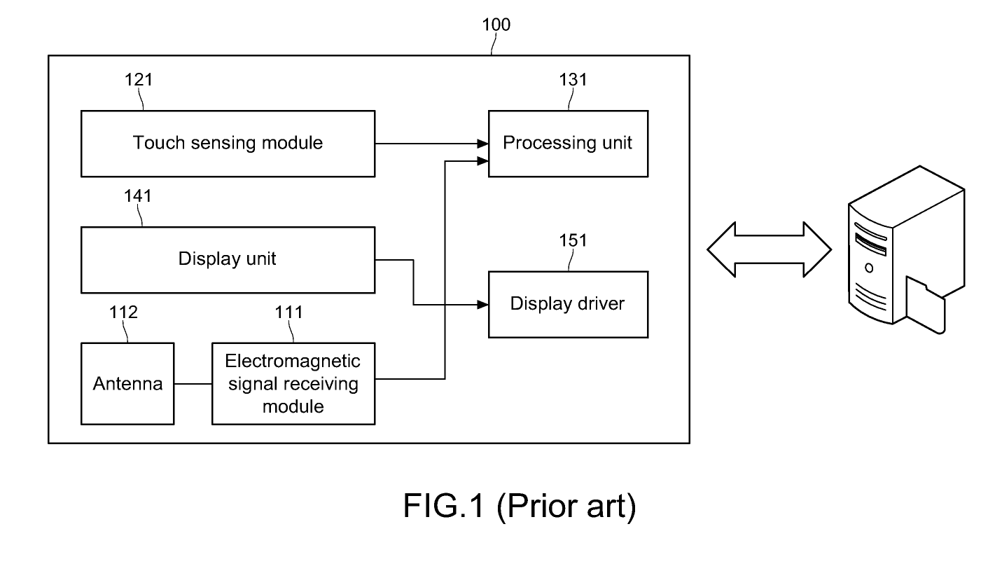

FIG. 2A is a schematic diagram of an embodiment of the disclosure;

FIG. 2B is a schematic diagram of the first direction signal lines and the second direction signal lines according to an embodiment of the disclosure;

FIG. 2C is a schematic diagram of the connections among the first direction signal lines, the first direction signal switch device and the first direction signal connection unit according to an embodiment of the disclosure;

FIG. 2D is a schematic diagram of the electromagnetic induction module receiving signals according to an embodiment of the disclosure;

FIG. 2E is a schematic diagram of the touch input module receiving signals according to an embodiment of the disclosure;

FIG. 3A is a flow chart of an embodiment of the disclosure; and

FIG. 3B is a schematic diagram of the switching of operation status according to an embodiment of the disclosure.

### DETAILED DESCRIPTION

The detailed features and advantages of the disclosure are described below in great detail through the following embodiments, the content of which is sufficient for those of ordinary skill in the art to understand the technical content of the disclosure and to implement the disclosure accordingly. Based upon the content of the specification, the claims, and the drawings, those of ordinary skill in the art can easily understand the relevant objectives and advantages of the disclosure.

A dual-mode tablet of the disclosure may cooperate with an induction pen and a finger. The dual-mode tablet may be a capacitive touch panel, a resistive touch panel or an optical touch panel. The dual-mode tablet may not only operate individually but also be implemented in various devices such as, but not limited to, a display device, a mobile phone, and a computer. In one embodiment, the dual-mode tablet is coupled to a display unit. For illustration purpose of the connection and the operation among the components in the dual-mode tablet, the embodiment of the individual dual-mode tablet is taken for illustration hereinafter.

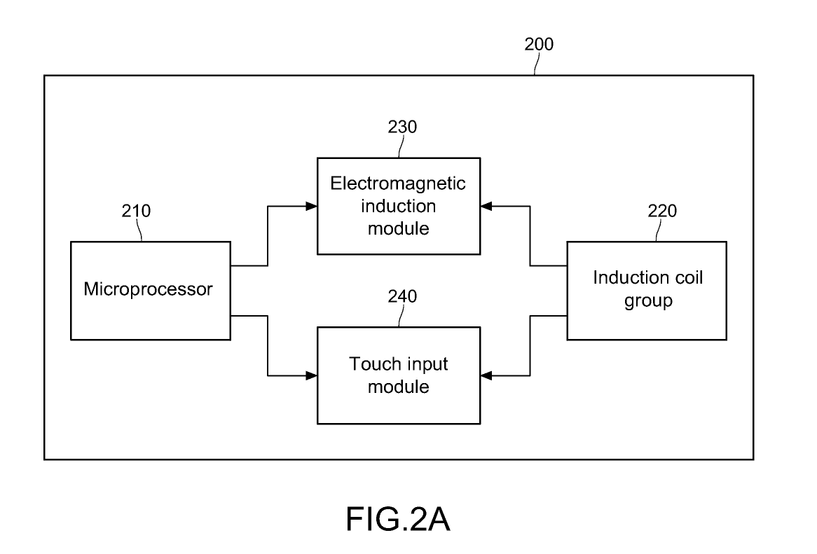

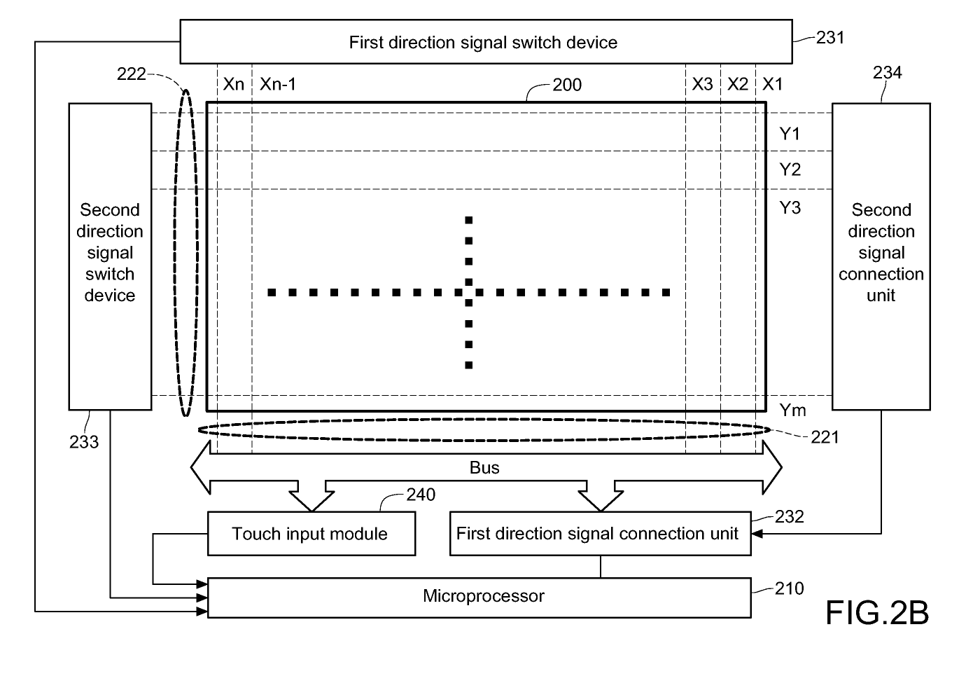

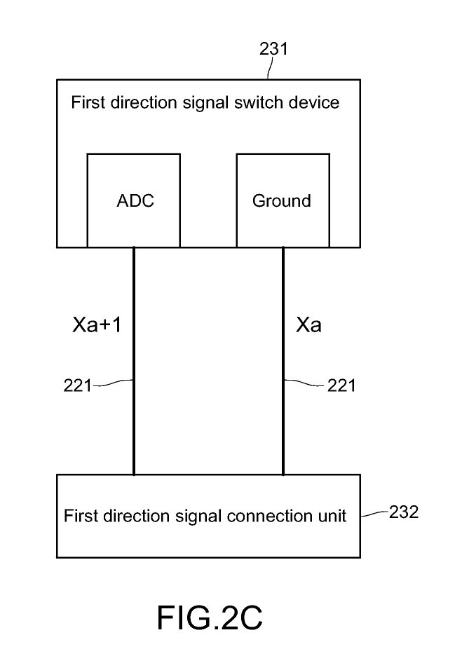

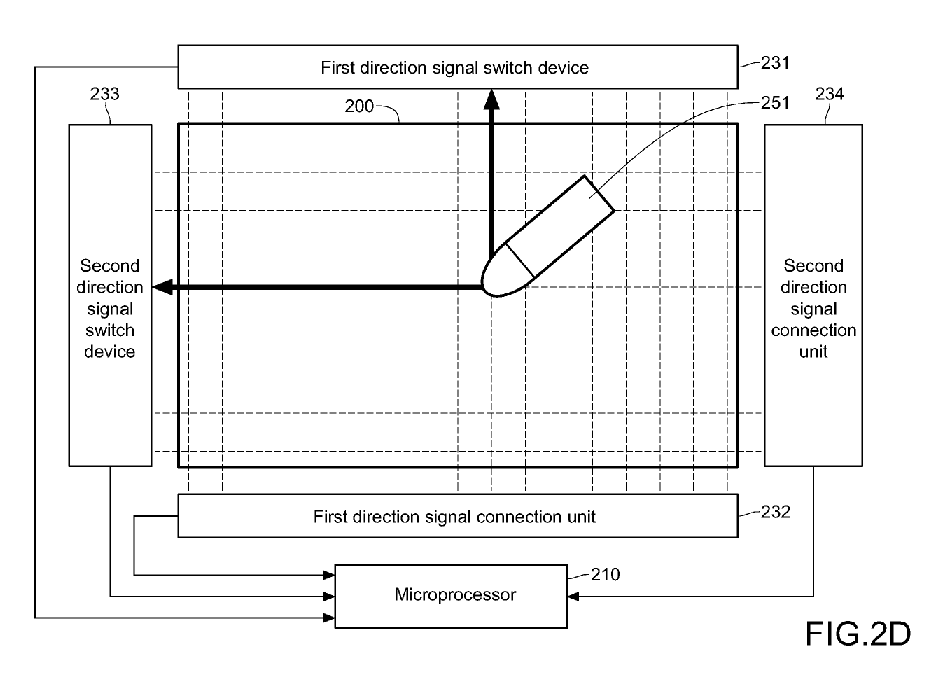

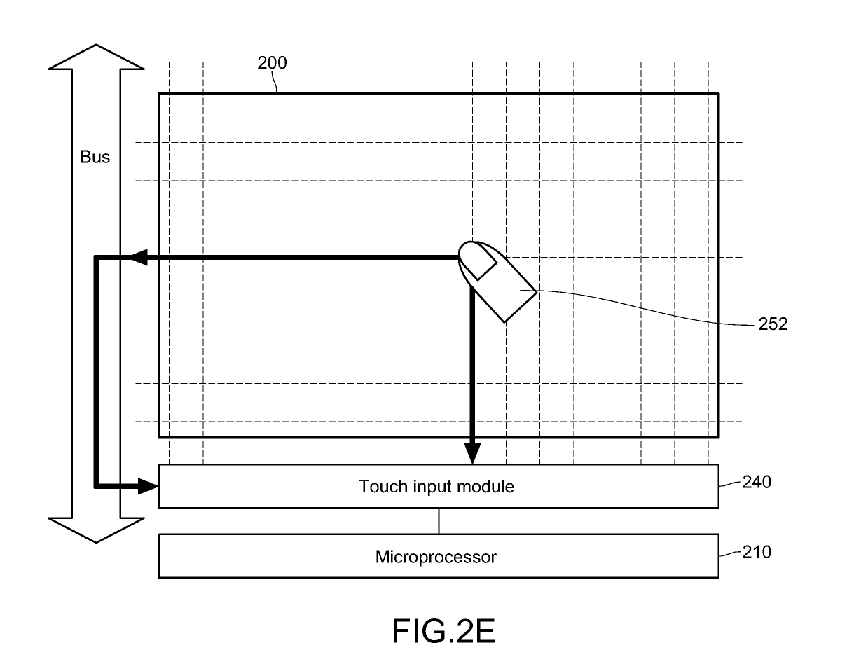

FIG. 2A illustrates a schematic diagram of an embodiment of the disclosure. The dual-mode tablet 200 cooperates with an induction pen under an electromagnetic induction mode and with finger under a touch input mode. The dual-mode tablet 200 includes a microprocessor 210, an induction coil group 220, an electromagnetic induction module 230 and a touch input module 240. The microprocessor 210 electronically connects to the electromagnetic induction module 230 and the touch input module 240. The induction coil group 220 electronically connects to one of the electromagnetic induction module 230 and the touch input module 240 selectively.

When the electromagnetic induction module 230 electronically connects to the induction coil group 220, the induction coil group 220 receives electromagnetic signals generated by which the induction pen approaches the dual-mode tablet 200. When the touch input module 240 electronically connects to the induction coil group 220, the induction coil group 220 receives touch input signals generated by finger touching on the dual-mode tablet 200. The detailed structure of the dual-mode tablet 200 is described in FIG. 2B.

FIG. 2B illustrates a schematic diagram of the first direction signal lines and the second direction signal lines according to an embodiment of the disclosure, which is based on the top view of the dual-mode tablet 200. The electromagnetic induction module 230 includes multiple first direction signal lines 221 and multiple second direction signal lines 222 among which are defined by thick dotted-line frames. The first direction signal lines 221 and the second direction signal lines 222 are respectively disposed at different layers to form a network structure.

The first direction signal lines 221 indicate the signal lines at the horizontal axis (X-axis), e.g. X1, X2, X3, Xn−1 and Xn, and the amount of the first direction signal lines 221 is n. The second direction signal lines 222 indicate the signal lines at the vertical axis (Y-axis), e.g. Y1, Y2, Y3 and Ym, and the amount of the second direction signal lines 222 is m. Both of n and m are nature numbers.

Besides, the electromagnetic induction module 230 further includes a first direction signal switch device 231, a first direction signal connection unit 232, a second direction signal switch device 233 and a second direction signal connection unit 234. The first direction signal connection unit 232 and the touch input module 240 connect to the first direction signal lines 221 via a bus respectively.

The microprocessor 210 respectively connects to the first direction signal switch device 231, the first direction signal connection unit 232, the second direction signal switch device 233 and the second direction signal connection unit 234 electronically. Two terminals of each first direction signal line 221 electronically connect to the first direction signal switch device 231 and the first direction signal connection unit 232 respectively. Two terminals of each second direction signal line 222 electronically connect to the second direction signal switch device 233 and the second direction signal connection unit 234 respectively. The detailed connections among the first direction signal switch device 231, the first direction signal connection unit 232, the second direction signal switch device 233 and the second direction signal connection unit 234 are described as below.

Referring to FIG. 2C, to designate the selected signal lines, the selected first direction signal lines 221 are defined as Xₐ, the selected second direction signal lines 222 are defined as Y_{b}, in which the suffix a is one of 1 to m, and the suffix b is one of 1 to n. For explanation of the connection and the operation among the components, the embodiment of two adjacent first direction signal lines 221, which are marked as Xₐ and Xₐ₊₁ respectively, is taken for illustration hereinafter. Moreover, the two adjacent first direction signal lines 221 are optionally selected based on different algorithms, that is, the microprocessor 210 may, but not limit to, select two first direction signal lines Xₐ and Xₐ₊₃ (not shown) having a greater interval therebetween, and thereby increasing the scanning rate thereof.

As set forth, one terminal of each first direction signal line 221 electronically connects to the first direction signal switch device 231, and the other terminal of each direction signal line 221 electronically connects to the first direction signal connection unit 232. More particularly, one terminal of the first direction signal line Xₐ of the first direction signal lines 221 electronically connects to an analog to digital converter (ADC) of the first direction signal switch device 231, one terminal of the first direction signal line Xₐ₊₁ of the first direction signal lines 221 electronically connects to the ground.

Similarly, two terminals of each of the second direction signal lines Y_{b} and Y_{b+1} (not shown) electronically connect to the second direction signal switch device 233 and the second direction signal connection unit 234 respectively.

When the dual-mode tablet 200 operates under the electromagnetic induction mode, the microprocessor 210 selects two of the first direction signal lines 221 in order and drives the first direction signal connection unit 232 to short-circuit the selected two first direction signal lines 221. Moreover, the microprocessor 210 selects two of the second direction signal lines 222 in order and drives the second direction signal connection unit 234 to short-circuit the selected two second direction signal lines 222. Whenever scanning once, the microprocessor 210 may determine whether the short-circuited status of every two selected signal lines is changed, and thereby determining whether the induction pen 251 approaches the dual-mode tablet 200 as shown in FIG. 2D.

When the dual-mode tablet 200 operates under the touch input mode, the microprocessor 210 drives the touch input module 240 to receive a touch input signal. The microprocessor 210 cuts off the communication between the electromagnetic induction module 230 and the induction coil group 220 while controlling the touch input module 240 to electronically connect to the induction coil group 220.

Under the touch input mode, the induction coil group 220 determines the position of the finger 252 according to the capacitance variance generated by which the finger 252 presses the dual-mode tablet 200. Because of the network structure formed among the first direction signal lines 221 and the second direction signal lines 222 in FIG. 2B, it may change the distance between the first direction signal lines 221 and the second direction signal lines 222 to press the dual-mode tablet 200. This causes the capacitance at the position where the dual-mode tablet 200 is pressed is changed. According to the capacitance variance, the touch input module 240 may know the position where the finger 252 is, as shown in FIG. 2E. In FIG. 2E, the thick line indicates the touch input signal generated at the position where the finger 252 presses, and indicates that the second direction signal lines at the left side connect to the touch input module 240 through the bus. The operation of the dual-mode tablet 200 is described as below.

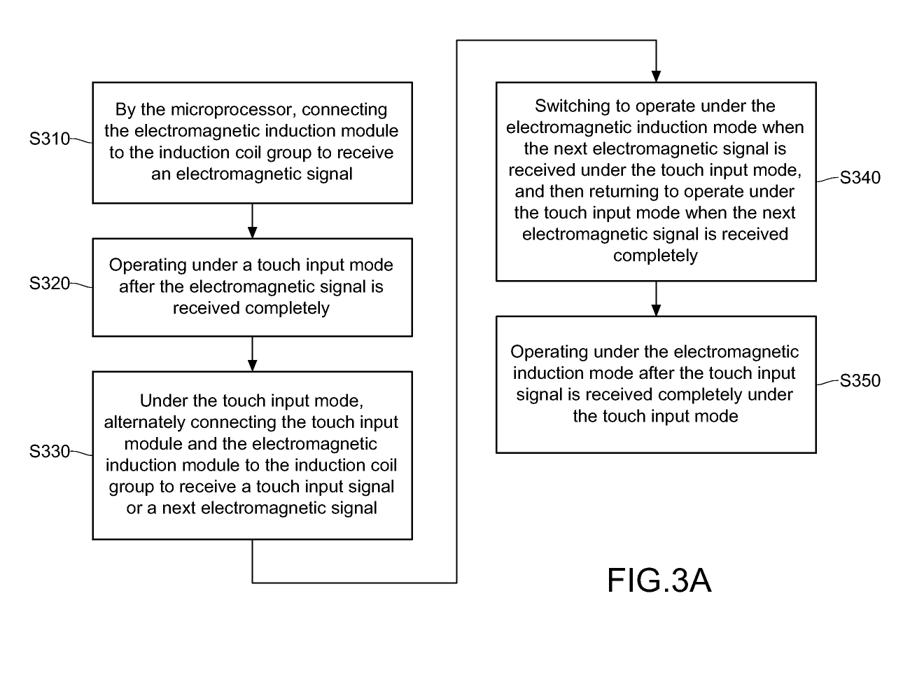

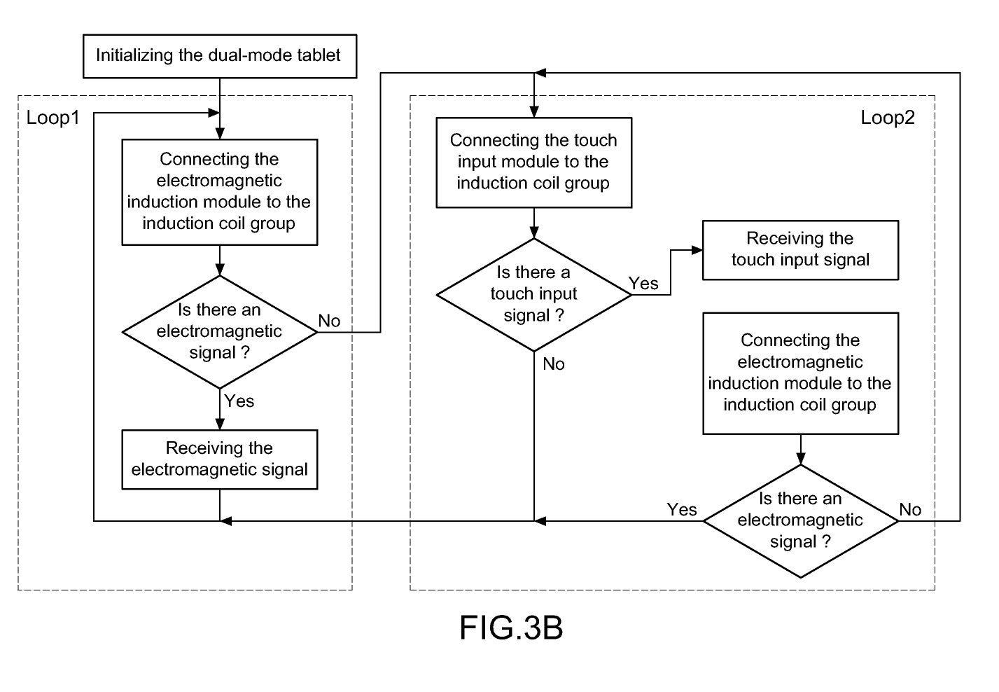

Referring to FIGS. 3A and 3B, a detecting and switching method for input signals according to the disclosure is shown. The electromagnetic induction module is controlled to electronically connect to the induction coil group by the microprocessor to receive one electromagnetic signal as shown in S310. After the electromagnetic signal is received completely, the dual-mode tablet is controlled by the microprocessor to operate under a touch input mode as shown in S320. Under the touch input mode, the touch input module and the electromagnetic induction module are controlled by the microprocessor to electronically connect to the induction coil group alternately to receive one touch input signal or one next electromagnetic signal as shown in S330. The dual-mode tablet is switched by the microprocessor to operate under the electromagnetic induction mode when the next electromagnetic signal is received under the touch input mode, and then returns to the touch input mode when the next electromagnetic signal is received completely as shown in S340. After the touch input signal is received completely under the touch input mode, the dual-mode tablet operates under the electromagnetic induction mode as shown in S350. The detail operation among the microprocessor, the electromagnetic induction module and the touch input module is described as below.

The dual-mode tablet 200 receives and processes corresponding input signals when operating under the electromagnetic induction mode and the touch input mode. The dual-mode tablet 200 is preset under the electromagnetic induction mode when operating initially, so the electromagnetic induction module 230 electronically connects to the induction coil group 220 as shown in S310. Under the electromagnetic induction mode, the microprocessor 210 receives one electromagnetic signal generated by which the induction pen 251 moves on the dual-mode tablet 200, via the induction coil group 220 and the electromagnetic induction module 230.

More particularly, the microprocessor 210 under the electromagnetic induction mode executes a first loop Loop1 to continuously detect whether any electromagnetic signal is received by the induction coil group 220. When one electromagnetic signal is received in the first loop Loop1, the microprocessor 210 repeatedly executes the first loop Loop1 to detect whether any electromagnetic signal is received by the induction coil group 220. In other words, the microprocessor 210 recounts the period of the first loop Loop1 to detect whether a next electromagnetic signal is received by the induction coil group 220, whenever one electromagnetic signal is received by the induction coil group 220.

In FIG. 3B, when receiving one electromagnetic signal in the first loop Loop1, the microprocessor 210 continuously operates under the electromagnetic induction mode. Otherwise, when receiving no electromagnetic signal in the first loop Loop1, the microprocessor 210 operates under the touch input mode instead of the electromagnetic induction mode as shown in S320. The period of the first loop Loop1 is set based on the area of the dual-mode tablet 200 or on the amount of signal lines (e.g. the first direction signal lines 221 and the second direction signal lines 222).

Subsequently, under the touch input mode, the touch input module 240 and the electromagnetic induction module 230 electronically connect to the induction coil group 220 alternately, and the microprocessor 210 detects whether any touch input signal or any electromagnetic signal is received by the induction coil group 220 in the second loop Loop2. The microprocessor 210 first controls the touch input module 240 to electronically connect to the induction coil group 220 and then controls the electromagnetic induction module 230 to electronically connect to the induction coil group 220. In other words, the microprocessor 210 alternately controls the touch input module 240 and the electromagnetic induction module 230 to electronically connect to the induction coil group 220.

In the second loop Loop2, the microprocessor 210 receives one touch input signal through the touch input module 240 and the induction coil group 220 when the touch input module 240 electronically connects to the induction coil group 220, and receives one electromagnetic signal through the electromagnetic induction module 230 and the induction coil group 220 when the electromagnetic induction module 230 electronically connects to the induction coil group 220, as shown in S330. The period of the second loop Loop2 is set based on the area of the dual-mode tablet 200 or on the amount of the signal lines.

When receiving one electromagnetic signal in the second loop Loop2, the microprocessor 210, by the manner of the first loop Loop1, continuously detects whether a next electromagnetic signal is received by the induction coil group 220. When the electromagnetic signal is received by the induction coil group 220 in the first loop Loop1, the microprocessor 210 maintains in the first loop Loop1 to detect whether a next electromagnetic signal is received by the induction coil group 220. When no other electromagnetic signal is received by the induction coil group beyond the period of the first loop Loop1, the microprocessor 210 returns to the electromagnetic induction mode as shown in FIG. 3B.

If simultaneously a user touches the dual-mode tablet 200 by the finger 252 and approach the dual-mode tablet 200 by the induction pen 251, the dual-mode tablet 200 is predefined to first receive the electromagnetic signal caused by the induction pen 251. Thus, the interference, which is caused by the user's hand and effects the determination of the position of the induction pen 251 while the dual-mode tablet 200 cooperates to the induction pen 251, may be reduced. Such a manner of avoiding interference is called “palm rejection.”

Beside the above operation method in the second loop Loop2, the disclosure provides a following other embodiment. When receiving the electromagnetic signal in the second loop Loop2, the microprocessor 210 continuously detects whether the electromagnetic signal is received by the induction coil group 220 in the manner of the first loop Loop1. Herein, the microprocessor 210 switches to perform the first loop Loop1 and records the residual period of the second loop Loop2. If the microprocessor 210 does not receive any electromagnetic signal after the period of the first loop Loop1, and the microprocessor 210 switches to perform the second loop Loop2 to perform the residual procedure corresponding to the residual period to continuously detect whether any touch input signal is received by the induction coil group 220.

According to the disclosure, via a single induction coil group, the dual-mode tablet may simultaneously receive input signals caused by the induction pen and the finger. Thus, the manufacture cost, the repair cost and even the inner components of the dual-mode tablet required by two different signal input ways may be reduced.

The disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and region of equivalency of the claims are to be embraced within their scope.

What is claimed is:

1. A dual-mode tablet, comprising:
an induction coil group;
an electromagnetic induction module, electronically connected to the induction coil group selectively and configured to receive electromagnetic signals;
a touch input module, electronically connected to the induction coil group selectively and configured to receive touch input signals; and
a microprocessor, electronically connected to the electromagnetic induction module and the touch input module and configured to control one of the electromagnetic induction module and the touch input module to electronically connect to the induction coil group;
wherein the electromagnetic induction module electronically connects to the induction coil group when the microprocessor operates under an electromagnetic induction mode, the microprocessor continuously operates under the electromagnetic induction mode and determines whether one next electromagnetic signal is received when one electromagnetic signal is received under the electromagnetic induction mode, and the microprocessor operates under a touch input mode instead of the electromagnetic induction mode when no next electromagnetic signal is received; and
the touch input module and the electromagnetic induction module electronically connects to the induction coil group alternately to receive one touch input signal or one next electromagnetic signal when the microprocessor operates under the touch input mode, and when the microprocessor detects the next electromagnetic signal exists in a second loop, the microprocessor switches to the touch input mode to receive the next electromagnetic signal until the next electromagnetic signal is received completely.

2. The dual-mode tablet according to claim 1, wherein the induction coil group comprises at least one first direction signal line and at least one second direction signal line.

3. The dual-mode tablet according to claim 2, wherein the electromagnetic induction module comprises a first direction signal switch device and a first direction signal connection unit, two terminals of each first direction signal line respectively and electronically connect to the first direction signal switch device and the first direction signal connection unit, and the first direction signal connection unit selects at least two of the first direction signal lines and makes the selected two first direction signal lines short-circuited.

4. The dual-mode tablet according to claim 2, wherein the electromagnetic induction module further comprises a second direction signal switch device and a second direction signal connection unit, two terminals of each second direction signal line respectively and electronically connect to the second direction signal switch device and the second direction signal connection unit, and the second direction signal connection unit selects at least two of the second direction signal lines and makes the selected two second direction signal lines short-circuited.

5. A detecting and switching method for input signals, adapted to a dual-mode tablet which comprises an electromagnetic induction module and a touch input module, and the method comprising:
electronically connecting the electromagnetic induction module to an induction coil group to receive an electromagnetic signal, by a microprocessor operating under an electromagnetic induction mode;
operating under a touch input mode by the microprocessor after the electromagnetic signal is received completely;
under the touch input mode, controlling the electromagnetic induction module and the touch input module to electronically connecting the induction coil group alternately to receive a touch input signal or a next electromagnetic signal;
switching to operate under the electromagnetic induction mode when the microprocessor detects the next electromagnetic signal exists under the touch input mode, and returning to operate under the touch input mode when the microprocessor receives the next electromagnetic signal completely; and
switching to operate under the electromagnetic induction mode after the microprocessor receives the touch input signal completely under the touch input mode.

6. The detecting and switching method according to claim 5, wherein the step, which the microprocessor receives the electromagnetic signal completely under the electromagnetic induction mode, comprises:
by the microprocessor, determining whether the electromagnetic signal is received in a first loop; and
repeatedly executing the first loop when the microprocessor receives the electromagnetic signal, until no next electromagnetic signal is received in the first loop.

7. The detecting and switching method according to claim 5, wherein the step, which the microprocessor receives the touch input signal completely under the touch input mode, comprises:
by the microprocessor, determining whether one of the next electromagnetic signal and the touch input signal is received in a second loop; and
counting a period of a first loop by the microprocessor while the microprocessor receives the next electromagnetic signal, until no other electromagnetic signal is received after the period of the first loop.

8. The detecting and switching method according to claim 5, wherein the step, which the microprocessor receives the touch input signal completely under the touch input mode, comprises:
by the microprocessor, determining whether one of the next electromagnetic signal and the touch input signal is received in a second loop;
by the microprocessor, recording the count of the second loop and counting a period of a first loop when the microprocessor receives the next electromagnetic signal, until no other electromagnetic signal is received after the period of the first loop; and
after the microprocessor returns to the second loop from the first loop, by the microprocessor, continuously detecting whether one of other electromagnetic signal and other touch input signal is received according to the count of the second loop, until the second loop is complete.
